(19) United States
(12) Patent Application Publication
(10) Pub. No.: US 2026/0178875 A1
(43) Pub. Date: Jun. 25, 2026

(54) UNIVERSAL MULTI-MODAL ARTIFICIAL INTELLIGENCE AGENT

(71) Applicant: LG ELECTRONICS INC., Seoul (KR)

(72) Inventors: Wooseong CHUNG, San Jose, CA (US); Hyunchul LEE, Mountain View, CA (US); Jacob SONG, Cupertino, CA (US); Sanghyun BYUN, Los Angeles, CA (US)

(73) Assignee: LG ELECTRONICS INC., Seoul (KR)

(21) Appl. No.: 19/427,819

(22) Filed: Dec. 19, 2025

Related U.S. Application Data
(60) Provisional application No. 63/735,911, filed on Dec. 19, 2024.

(51) Int. Cl. G06N 3/042; G06N 3/092

(52) U.S. Cl. CPC G06N 3/042; G06N 3/092

(57) ABSTRACT

A device and method for providing a multimodal artificial intelligence home agent implemented using a multimodal transformer model configured to process input data having at least two modalities, by receiving an input from a home environment; processing the input via a middleware interface configured to generate token representations of the input; providing the token representations to a joint attention model configured to receive the generated tokens and generate cross-modal contextualized embeddings, providing the embeddings to the multimodal transformer model to obtain an output representing an executable action in response to the input; and causing one or more devices associated with the home environment to execute a task associated with the executable action in response to the input.

### CROSS-REFERENCE TO RELATED APPLICATION

Pursuant to 35 U.S.C. § 119(e), this application claims the benefit of U.S. Provisional Patent Application No(s). 63/735,911, filed on Dec. 19, 2024, the contents of which are hereby incorporated by reference herein in its entirety.

### BACKGROUND

Agentic AI systems have significantly enhanced quality-of-life services across various business sectors. However, many of these systems remain highly specialized, capable of performing only specific analyses or actions within their domains of expertise. This specialization often necessitates the use of different services or architectures for distinct types of tasks, undermining usability and creating a public perception that such systems are fragmented, impractical, and in their early stages of development.

The proposed system addresses these challenges by introducing a universal, multi-modal agent capable of handling diverse tasks. By seamlessly integrating perception, planning, execution, and memory layers, the system enables a more comprehensive understanding of tasks, enhancing its versatility and applicability across domains. This unified, master agentic model not only simplifies maintenance and upgrades but also improves adaptability and performance over time, resulting in increased model perplexity and robustness.

As examples to the use cases of the model, 3 goals are proposed: seamless multi-modal interaction to simplify complex tasks for home appliances and home robots, operational downtime reduction of appliances through intelligent troubleshooting, and user engagement and satisfaction improvement through personalized and proactive AI responses for home appliances, smart screens, and home robots.

While AI solutions have been widely applied to personal or home agent contexts, the implementations mostly have glaring limitations particularly when applied to the above examples, and often result in user frustration due to increased time to solution and unnecessary complexity, decreasing brand loyalty and trust.

As an example, an existing solution AssistGPT utilizes OpenAI's GPT (Generative Pre-trained Transformer) as a main planner with multiple executor tools to have agentic properties. It further features an inspector that can analyze visual inputs and intermediate results and learner that checks reasoning to retry or save the tries. However, this solution relies on external models for visual input processing and struggles with highly intricate workflows.

Other existing solutions integrate with structured and unstructured knowledge databases and use specified access permissions to deliver context-aware responses. However, these solutions function primarily as a data-retrieval and analysis agent and cannot analyze complex multi-modal inputs, such as images, video, or audio, to fetch the correct data.

Further, many existing LLM-based agents rely on Retrieval-Augmented Generation (RAG), and their confidence may be limited by the model's ability to call appropriate APIs, and may be limited to generating a response based on only a limited set of documents.

To address these and other issues, the present disclosure provides a system implementing multi-modal layers, tightly integrated for robustness, which can be integrated to any home or personal device, robots, and PCs. Through a hybrid approach for operation processing, the present disclosure provides improvements in quality of life of users through various means such as personalized home ambiance control, easier maintenance, and better security, as just a few examples.

### SUMMARY

Accordingly, the present disclosure relates to systems and methods for integrating heterogeneous data input modalities, including but not limited to textual data, image data, video data, sensor data, and action-related data, within a unified machine learning model. The unified model is configured to jointly perform perception, reasoning, and planning operations based on multimodal inputs, thereby enabling coordinated decision-making and response generation. Embodiments of the disclosure reduce reliance on separate, modality-specific processing components, thus improving computational efficiency, scalability, and responsiveness.

An embodiment of the present disclosure includes computer-implemented device for providing a multimodal artificial intelligence (AI) home agent, the device comprising: one or more processors; and a memory configured to store instructions thereon, which when executed by the one or more processors, causes the device to operate a multimodal transformer model configured to process input data having at least two modalities and perform operations including: receiving an input from a home environment; processing the input via a middleware interface configured to generate token representations of the input; providing the token representations to a joint attention model configured to receive the generated tokens and generate cross-modal contextualized embeddings, providing the embeddings to the multimodal transformer model to obtain an output representing an executable action in response to the input; and causing one or more devices associated with the home environment to execute a task associated with the executable action in response to the input.

According to an embodiment, the joint attention model is included in a perception layer of the multimodal transformer model that is configured to extract relevant features from input data having the at least two modalities including at least text data, image data, video data, or audio data.

According to an embodiment, the multimodal transformer model further includes a planning layer configured to generate an actionable plan responsive to the input based on the provided embeddings, and the planning layer is trained using a plurality of input low-rank adaptation (LoRa) layers each dedicated to training parameters of the model for generating the actionable plan on a distinct expert knowledge base.

According to an embodiment, the multimodal transformer model further includes an action layer configured to generate the executable action based on the actionable plan, and the action layer is trained using a plurality of output low-rank adaptation (LoRa) layers each dedicated to training parameters of the model for generating the executable action on a distinct expert skillset base.

According to an embodiment, the expert knowledge bases of the plurality of input LoRa layers respectively correspond to the expert skillset bases of the plurality of output LoRa layers.

According to an embodiment, one or more of the plurality of output LoRa layers are configured to be further trained to adapt a new expert skillset base by a skill bootstrap teacher model, the skill bootstrap teacher model is configured to receive as input the input received from the home environment and the executed task associated with the executable action and generate a score for the executed task, and the score is used to train the one or more of the plurality of output LoRa layers to improve the executed task by reinforcement learning.

According to an embodiment, the output from the multimodal transformer model includes a request to a user of the home environment for additional data or information related to the received input.

According to an embodiment, the output from the multimodal transformer model generated using one input LoRa layer and one output LoRa layer is utilized in a subsequent processing by the multimodal transformer model which invokes processing by another input LoRa layer and another output LoRa layer.

According to an embodiment, the memory is further configured to store user-related data for utilization in a memory retrieval augmentation framework and the operations further comprise providing a memory manager for providing the multimodal transformer model with personalized data to be considered in executing the task in response to the input.

According to an embodiment, the distinct expert skillset bases of the plurality of output LoRa layers comprise skillsets for speech generation, image generation, and robotic component controls

Yet another embodiment of the present disclosure includes a method for providing a multimodal artificial intelligence (AI) home agent, the method comprising:
receiving an input from a home environment; processing the input via a middleware interface associated with a multimodal transformer model configured to process input data having at least two modalities, wherein the middleware interface is configured to generate token representations of the input; providing the token representations to a joint attention model configured to receive the generated tokens and generate cross-modal contextualized embeddings; providing the embeddings to the multimodal transformer model to obtain an output representing an executable action in response to the input; and causing one or more devices associated with the home environment to execute a task associated with the executable action in response to the input.

According to an embodiment, the joint attention model is included in a perception layer of the multimodal transformer model that is configured to extract relevant features from input data having the at least two modalities including at least text data, image data, video data, or audio data.

According to an embodiment, the multimodal transformer model further includes a planning layer configured to generate an actionable plan responsive to the input based on the provided embeddings, and the planning layer is trained using a plurality of input low-rank adaptation (LoRa) layers each dedicated to training parameters of the model for generating the actionable plan on a distinct expert knowledge base.

According to an embodiment, the multimodal transformer model further includes an action layer configured to generate the executable action based on the actionable plan, and wherein the action layer is trained using a plurality of output low-rank adaptation (LoRa) layers each dedicated to training parameters of the model for generating the executable action on a distinct expert skillset base.

According to an embodiment, the expert knowledge bases of the plurality of input LoRa layers respectively correspond to the expert skillset bases of the plurality of output LoRa layers.

According to an embodiment, one or more of the plurality of output LoRa layers are configured to be further trained to adapt a new expert skillset base by a skill bootstrap teacher model, the skill bootstrap teacher model is configured to receive as input the input received from the home environment and the executed task associated with the executable action and generate a score for the executed task, and the score is used to train the one or more of the plurality of output LoRa layers to improve the executed task by reinforcement learning.

According to an embodiment, the output from the multimodal transformer model includes a request to a user of the home environment for additional data or information related to the received input.

According to an embodiment, the output from the multimodal transformer model generated using one input LoRa layer and one output LoRa layer is utilized in a subsequent processing by the multimodal transformer model which invokes processing by another input LoRa layer and another output LoRa layer.

According to an embodiment, the method further comprises storing user-related data for utilization in a memory retrieval augmentation framework and providing the multimodal transformer model with personalized data based on the user-related data to be considered in executing the task in response to the input

According to an embodiment, the distinct expert skillset bases of the plurality of output LoRa layers comprise skillsets for speech generation, image generation, and robotic component controls.

Yet another embodiment is directed to a non-transitory computer readable medium having instructions stored thereon, which when executed by one or more processors of a device cause the device to perform operations including: receiving an input from a home environment; processing the input via a middleware interface associated with a multimodal transformer model configured to process input data having at least two modalities, wherein the middleware interface is configured to generate token representations of the input; providing the token representations to a joint attention model configured to receive the generated tokens and generate cross-modal contextualized embeddings; providing the embeddings to the multimodal transformer model to obtain an output representing an executable action in response to the input; and causing one or more devices associated with the home environment to execute a task associated with the executable action in response to the input.

In accordance with some implementations, a non-transitory computer readable storage medium has stored therein instructions, which, when executed by one or more processors of an electronic device, cause the electronic device to perform or cause performance of any of the methods described herein. In accordance with some implementations, an electronic device includes: one or more processors, a non-transitory memory, and means for performing or causing performance of any of the methods described herein.

The present disclosure is not limited to what has been described above, and other aspects and advantages of the present disclosure not mentioned above will be understood through the following description of implementations of the present disclosure. Further, it will be understood that the aspects and advantages of the present disclosure may be achieved by the configurations described in claims and combinations thereof.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is an example an AI system in accordance with an embodiment of the present disclosure.

FIG. 2 is an example of an AI server according to an embodiment of the present disclosure.

FIG. 3 is an example of an example device which may be used to embody, implement, execute, or perform embodiments of the present disclosure.

FIG. 4 is an example of an edge device according to an embodiment of the present disclosure.

FIG. 5 is a block diagram of a neural network in accordance with an embodiment of the present disclosure.

FIG. 6 is a block diagram of a transformer architecture in accordance with an embodiment of the present disclosure.

FIGS. 7-9 are examples of a system for providing a universal multi-modal AI home agent according to an embodiment of the present disclosure.

FIGS. 10 and 11 are examples of Mixture-of-LoRa expert layers configurations according to an embodiment of the present disclosure.

FIG. 12 is an example of a memory manager according to an embodiment of the present disclosure.

FIG. 13 is an example flowchart for providing a multimodal AI home agent according to an embodiment of the present disclosure.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

Hereinafter, the implementations disclosed in the present specification will be described in detail with reference to the accompanying drawings, the same or similar elements regardless of a reference numeral are denoted by the same reference numeral, and a duplicate description thereof will be omitted. In the following description, the terms “module” and “unit” for referring to elements are assigned and used interchangeably in consideration of convenience of explanation, and thus, the terms per se do not necessarily have different meanings or functions. Wherever possible, the same reference numbers will be used throughout the drawings to refer to the same or like parts. In the following description, known functions or structures, which may confuse the substance of the present disclosure, are not explained. The accompanying drawings are used to help easily explain various technical features, and it should be understood that the implementations presented herein are not limited by the accompanying drawings. As such, the present disclosure should be construed to extend to any alterations, equivalents, and substitutes in addition to those which are particularly set out in the accompanying drawings.

The terminology used herein is used for the purpose of describing particular example implementations only and is not intended to be limiting. As used herein, the singular forms “a,” “an,” and “the” may be intended to include the plural forms as well, unless the context clearly indicates otherwise. The terms “comprises,” “comprising,” “includes,” “including,” “containing,” “has,” “having” or other variations thereof are inclusive and therefore specify the presence of stated features, integers, steps, operations, elements, and/or components, but do not preclude the presence or addition of one or more other features, integers, steps, operations, elements, components, and/or groups thereof. Furthermore, these terms such as “first,” “second,” and other numerical terms, are used only to distinguish one element from another element. These terms are generally only used to distinguish one element from another.

Hereinafter, implementations of the present disclosure will be described in detail with reference to the accompanying drawings. Like reference numerals designate like elements throughout the specification, and overlapping descriptions of the elements will not be provided.

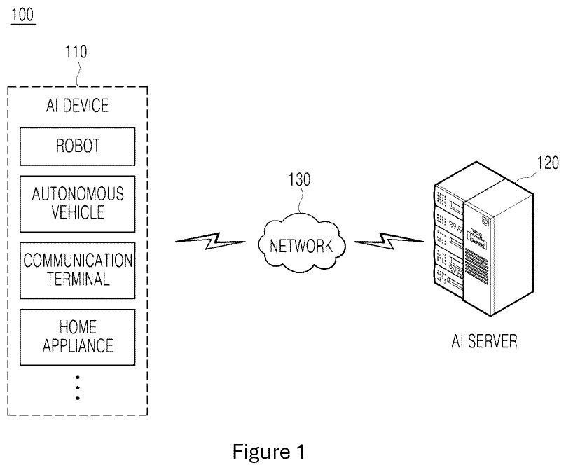

FIG. 1 is a view illustrating an example of an AI system including an AI device, an AI server, and a network connecting the above-mentioned components. While pertinent features are shown, those of ordinary skill in the art will appreciate from the present disclosure that various other features have not been illustrated for the sake of brevity and so as not to obscure more pertinent aspects of the example implementations disclosed herein.

Referring to FIG. 1, the AI device 100 may include an artificial intelligence based apparatus of the present disclosure and for example, include at least one of a robot, an autonomous vehicle, a communication terminal (for example, a mobile phone, a smart phone, or a tablet PC), an edge device, or a home appliance (for example, a television, washing machine, or robot cleaner).

Here, artificial intelligence refers to a field of studying artificial intelligence or a methodology to create the artificial intelligence and machine learning refers to a field of defining various problems treated in the artificial intelligence field and studying a methodology to solve the problems. In addition, machine learning may be defined as an algorithm for improving performance with respect to a task through repeated experience with respect to the task.

An artificial neural network (ANN) is a model used in machine learning, and may refer in general to a model with problem-solving abilities, composed of artificial neurons (nodes) forming a network by a connection of synapses. The ANN may be defined by a connection pattern between neurons on different layers, a learning process for updating model parameters, and an activation function for generating an output value.

The ANN may include an input layer, an output layer, and may selectively include one or more hidden layers. Each layer includes one or more neurons, and the ANN may include synapses that connect the neurons to one another. In an ANN, each neuron may output a function value of an activation function with respect to the input signals inputted through a synapse, weight, and bias.

A model parameter refers to a parameter determined through learning, and may include weight of synapse connection, bias of a neuron, and the like. Moreover, hyperparameters refer to parameters which are set before learning in a machine learning algorithm, and include a learning rate, a number of iterations, a mini-batch size, an initialization function, and the like.

The objective of training an ANN is to determine a model parameter for significantly reducing a loss function. The loss function may be used as an indicator for determining an optimal model parameter in a learning process of an artificial neural network.

The machine learning may train an artificial neural network by supervised learning.

Supervised learning may refer to a method for training an artificial neural network with training data that has been given a label. In addition, the label may refer to a target answer (or a result value) to be guessed by the artificial neural network when the training data is inputted to the artificial neural network.

As a result, the artificial intelligence based object identifying apparatus trains the artificial neural network using a machine learning algorithm or requests a trained artificial neural network from the AI server 120 to receive the trained artificial neural network from the AI server 120. Further, when the image is received, the object identifying apparatus may estimate a type of the object in the received image using the trained artificial neural network.

When the AI server 120 receives the request for the trained artificial neural network from the AI device 110, the AI server 120 may train the artificial neural network using the machine learning algorithm and provide the trained artificial neural network to the AI device 110. The AI server 120 may be composed of a plurality of servers to perform distributed processing. In this case, the AI server 120 may be included as a configuration of a portion of the AI device 110, and may thus perform at least a portion of the AI processing together.

The network 130 may connect the AI device 110 and the AI server 120. The network 130 may include a wired network such as a local area network (LAN), a wide area network (WAN), a metropolitan area network (MAN), or an integrated service digital network (ISDN), and a wireless network such as a wireless LAN, a CDMA, Bluetooth®, or satellite communication, but the present disclosure is not limited to these examples. The network 130 may also send and receive information using short distance communication and/or long distance communication. The short-range communication may include Bluetooth®, radio frequency identification (RFID), infrared data association (IrDA), ultra-wideband (UWB), ZigBee, and Wi-Fi (wireless fidelity) technologies, and the long-range communication may include code division multiple access (CDMA), frequency division multiple access (FDMA), time division multiple access (TDMA), orthogonal frequency division multiple access (OFDMA), and single carrier frequency division multiple access (SC-FDMA).

The network 130 may include connection of network elements such as a hub, a bridge, a router, a switch, and a gateway. The network 130 can include one or more connected networks, for example, a multi-network environment, including a public network such as an internet and a private network such as a safe corporate private network. Access to the network 130 may be provided through one or more wire-based or wireless access networks. Furthermore, the network 130 may support the Internet of Things (IoT) network for exchanging and processing information between distributed elements such as things, 3G, 4G, Long Term Evolution (LTE), 5G communications, or the like.

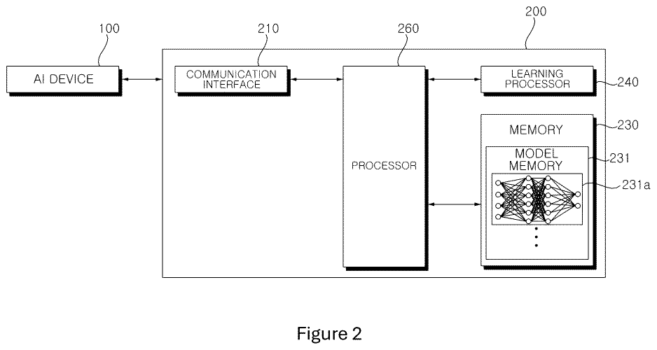

FIG. 2 is a diagram for illustrating the configuration of an artificial intelligence server according to an embodiment of the present disclosure.

Referring to FIG. 2, the AI server 200 may refer to a device that trains an artificial neural network using a machine learning algorithm or uses a learned artificial neural network. The AI server 200 may be composed of a plurality of servers to perform distributed processing. The AI server 200 may be included as a part of the artificial intelligence device 100 and may perform at least part of the AI processing.

The AI server 200 may include a communication interface 210, a memory 230, a learning processor 240, and a processor 260. The communication interface 210 may transmit and receive data with an external device such as the artificial intelligence device 100. The memory 230 may include a model memory 231. The model memory 231 may store a model (or artificial neural network, 231a) that is being trained or has been learned through the learning processor 240.

The learning processor 240 may train the artificial neural network 231a using training data. The learning model may be used while mounted on the AI server 200 of the artificial neural network, or may be mounted and used on an external device such as the artificial intelligence device 100.

The learning model may be implemented in hardware, software, or a combination of hardware and software. When part or all of the learning model is implemented as software, one or more instructions constituting the learning model may be stored in the memory 230. The processor 260 may infer a result value for new input data using a learning model and generate a response or control command based on the inferred result value.

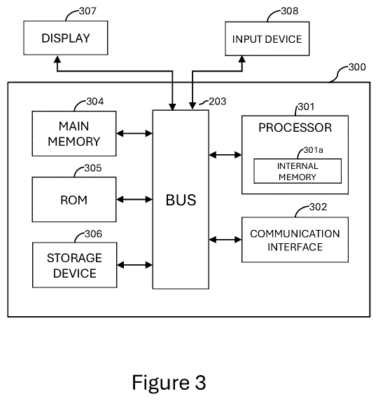

Referring now to FIG. 3, an illustration of an example device 300 is provided which may be used to embody, implement, execute, or perform embodiments of the present disclosure. The term device may be referenced, however it will be understood by those of ordinary skill that device 300 may be implemented as, or be implemented as a part of, various other components and/or devices, including, but not limited to a robot, an autonomous vehicle, a communication or computational terminal (for example, a mobile phone, a smart phone, laptop or a tablet PC), an edge device, or a home appliance or device (for example, a television, washing machine, a refrigerator, or robot cleaner, or the like).

In selected embodiments, the device 300 may include a bus 303 (or multiple buses) or other communication mechanism, a processor 301, processor internal memory 301a, main memory 304, read only memory (ROM) 305, one or more additional storage devices 306, and/or a communication interface 302, or the like or sub-combinations thereof. The embodiments described herein may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof. In all embodiments, the various components described herein may be implemented as a single component, or alternatively may be implemented in various separate components.

A bus 303 or other communication mechanism, including multiple such buses or mechanisms, may support communication of information within the device 300. The processor 301 may be connected to the bus 303 and process information. In selected embodiments, the processor 301 may be a specialized or dedicated microprocessor configured to perform particular tasks in accordance with the features and aspects disclosed herein by executing machine-readable software code defining the particular tasks. In some embodiments, multiple processors 201 may be provided with each processing unit dedicated to a particular specialized task, such as graphics processing or artificial intelligence related processing.

Main memory 304 (e.g., random access memory—or RAM—or other dynamic storage device) may be connected to the bus 303 and store information and instructions to be executed by the processor 301. Processor 301 may also include internal memory 301a, such as CPU cache implemented by SRAM, for storing data used for executing instructions. Utilization of internal memory 301a may optimize data and memory management by reducing memory bandwidth usage with main memory 304. Although FIG. 3 depicts internal memory 301a as a component of processor 301, it will be understood that embodiments are included wherein internal memory 301a is a separate component apart from processor 301. Main memory 304 may also store temporary variables or other intermediate information during execution of such instructions.

ROM 305 or some other static storage device may be connected to a bus 303 and store static information and instructions for the processor 201. An additional storage device 306 (e.g., a magnetic disk, optical disk, memory card, or the like) may be connected to the bus 303. The main memory 304, ROM 305, and the additional storage device 306 may include a non-transitory computer-readable medium holding information, instructions, or some combination thereof, for example instructions that when executed by the processor 301, cause the device 300 to perform one or more operations of a method as described herein. A communication interface 302 may also be connected to the bus 303. A communication interface 302 may provide or support two-way data communication between a device 300 and one or more external devices (e.g., other devices contained within the computing environment).

In selected embodiments, the device 300 may be connected (e.g., via a bus) to a display 307. The display 307 may use any suitable mechanism to communicate information to a user of a device 300. For example, the display 307 may include or utilize a liquid crystal display (LCD), light emitting diode (LED) display, projector, or other display device to present information to a user of the computer 100 in a visual display. One or more input devices 308 (e.g., an alphanumeric keyboard, remote controller, mouse, microphone, stylus pen) may be connected to the bus 303 to communicate information and commands to the device 300. In selected embodiments, one input device 308 may provide or support control over the positioning of a cursor to allow for selection and execution of various objects, files, programs, and the like provided by the device 300 and displayed by the display 307.

The device 300 may be used to transmit, receive, decode, display, or the like one or more image or video files. In selected embodiments, such transmitting, receiving, decoding, and displaying may be in response to the processor 301 executing one or more sequences of one or more instructions contained in main memory 304. Such instructions may be read into main memory 304 from another non-transitory computer-readable medium (e.g., a storage device).

Execution of sequences of instructions contained in main memory 304 may cause the processor 301 to perform one or more of the procedures or steps described herein. In selected embodiments, one or more processors in a multi-processing arrangement may also be employed to execute sequences of instructions contained in main memory 304. Alternatively, or in addition thereto, firmware may be used in place of, or in connection with, software instructions to implement procedures or steps in accordance with the features and aspects disclosed herein. Thus, embodiments in accordance with the features and aspects disclosed herein may not be limited to any specific combination of hardware circuitry and software.

Non-transitory computer readable medium may refer to any medium that participates in holding instructions for execution by the processor 301, or that stores data for processing by a computer, and comprise all computer-readable media, with the sole exception being a transitory, propagating signal. Such a non-transitory computer readable medium may include, but is not limited to, non-volatile media, volatile media, and temporary storage media (e.g., cache memory). Non-volatile media may include optical or magnetic disks, such as an additional storage device. Volatile media may include dynamic memory, such as main memory. Common forms of non-transitory computer-readable media may include, for example, a hard disk, a floppy disk, magnetic tape, or any other magnetic medium, a CD-ROM, DVD, Blu-ray or other optical medium, RAM, PROM, EPROM, FLASH-EPROM, any other memory card, chip, or cartridge, or any other memory medium from which a computer can read.

In selected embodiments, a communication interface 302 may provide or support external, two-way data communication to or via a network link. For example, a communication interface 302 may be a wireless network interface controller or a cellular radio providing a data communication network connection. Alternatively, a communication interface 202 may comprise a local area network (LAN) card providing a data communication connection to a compatible LAN. In any such embodiment, a communication interface 302 may send and receive electrical, electromagnetic, or optical signals conveying information.

A network link may provide data communication through one or more networks to other data devices (e.g., other devices such as 300, or terminals of various other types). For example, a network link may provide a connection through a local network of a host computer or to data equipment operated by an Internet Service Provider (ISP). An ISP may, in turn, provide data communication services through the Internet. Accordingly, a device 300 may send and receive commands, data, or combinations thereof, including program code, through one or more networks, a network link, and communication interface 302. Thus, the device 300 may interface or otherwise communicate with a remote server, or some combination thereof.

The various devices, modules, terminals, and the like discussed herein may be implemented on a computer by execution of software comprising machine instructions read from computer-readable medium, as discussed above. In certain embodiments, several hardware aspects may be implemented using a single computer, in other embodiments multiple computers, input/output systems and hardware may be used to implement the system.

For a software implementation, certain embodiments described herein may be implemented with separate software modules, such as procedures and functions, each of which perform one or more of the functions and operations described herein. The software codes can be implemented with a software application written in any suitable programming language and may be stored in memory and executed by a controller or processor.

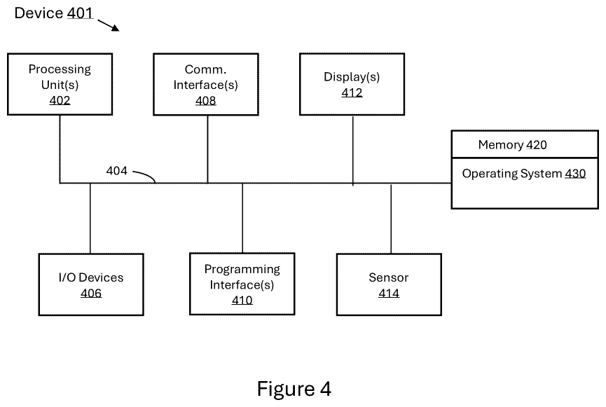

FIG. 4 is a block diagram of an example of a device 401, also referred to as an edge device, deployed device, target computing platform, or the like, in accordance with some implementations. While certain specific features are illustrated, those of ordinary skill in the art will appreciate from the present disclosure that various other features have not been illustrated for the sake of brevity, and so as not to obscure more pertinent aspects of the implementations disclosed herein.

To that end, as a non-limiting example, in some implementations the edge device (in some cases implemented as the device 300 shown in FIG. 3) or the device 401 includes one or more processing units 402 (e.g., microprocessors, ASICs, FPGAs, GPUs, CPUs, processing cores, and/or the like), one or more I/O devices and sensors 406, one or more communications interfaces 408 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like, type interfaces), one or more programming (e.g., I/O) interfaces 410, one or more displays 412, one or more exterior image sensors 414, a memory 420, and one or more communication buses 404 for interconnecting these and various other components.

In some implementations, the one or more communication buses 404 include circuitry that interconnects and controls communications between system components.

In some implementations, the one or more displays 412 are capable of presenting content. In some implementations, the one or more displays 412 are also configured to present flat video content to the user (e.g., a 2-dimensional or “flat” audio video interleave (AVI), flash video (FLV), Windows Media Video (WMV), or the like file associated with a TV episode or a movie, or live video pass-through of the operating environments.

In some implementations, the one or more displays 412 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro mechanical systems (MEMS), and/or the like display types. In some implementations, the one or more displays 212 correspond to diffractive, reflective, polarized, holographic, etc. waveguide displays. For example, the device 401 includes a single display. In another example, the device 401 includes a display for each eye of the user.

In some implementations, the one or more exterior image sensors 414 are configured to obtain image data frames. For example, the one or more optional exterior-and/or interior-facing image sensors 414 correspond to one or more RGB cameras (e.g., with a complementary metal-oxide-semiconductor (CMOS) image sensor, or a charge-coupled device (CCD) image sensor), infrared (IR) image sensors, event-based cameras, and/or the like.

The memory 420 includes high-speed random-access memory, such as DRAM, SRAM, DDR RAM, or other random-access solid-state memory devices. In some implementations, the memory 420 includes non-volatile memory, such as one or more magnetic disk storage devices, optical disk storage devices, flash memory devices, or other non-volatile solid-state storage devices. The memory 420 optionally includes one or more storage devices remotely located from the one or more processing units 402. The memory 420 comprises a non-transitory computer readable storage medium. In some implementations, the memory 420 or the non-transitory computer readable storage medium of the memory 420 stores the following programs, modules and data structures, or a subset thereof including an optional operating system 430. The optional operating system 430 includes procedures for handling various basic system services and for performing hardware dependent tasks.

FIGS. 1-4 are intended more as a functional descriptions of the various features that could be present in a particular implementation as opposed to a structural schematic of the implementations described herein. As recognized by those of ordinary skill in the art, items shown separately could be combined and some items could be separated. For example, some functional modules shown separately in FIGS. 1-4 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

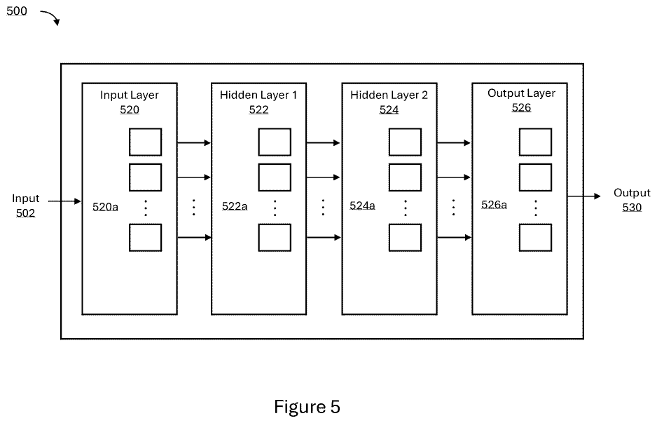

FIG. 5 is a block diagram of an example neural network 500 according to some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations, the neural network 500 includes an input layer 520, a first hidden layer 522, a second hidden layer 524, and an output layer 526. While the neural network 500 includes two hidden layers as an example, those of ordinary skill in the art will appreciate from the present disclosure that one or more additional hidden layers are also present in various implementations. Adding additional hidden layers adds to the computational complexity and memory demands but may improve performance for some applications.

In various implementations, the input layer 520 is coupled (e.g., configured) to receive various inputs 502 (e.g., image data). For example, the input layer 520 receives pixel data from one or more image sensors (e.g., the sensor 414 shown in FIG. 4). In various implementations, the input layer 520 includes a number of long short-term memory (LSTM) logic units 420a, which are also referred to as model(s) of neurons by those of ordinary skill in the art. In some such implementations, an input matrix from the features to the LSTM logic units 520a include rectangular matrices. For example, the size of this matrix is a function of the number of features included in the feature stream.

In some implementations, the first hidden layer 522 includes a number of LSTM logic units 522a. In some implementations, the number of LSTM logic units 522a ranges between approximately 10-500. Those of ordinary skill in the art will appreciate that, in such implementations, the number of LSTM logic units per layer is orders of magnitude smaller than previously known approaches (being of the order of O(101) to O(102)), which allows such implementations to be embedded in highly resource-constrained devices. As illustrated in the example of FIG. 5, the first hidden layer 522 receives its inputs from the input layer 520. For example, the first hidden layer 522 performs one or more of following: a convolutional operation, a nonlinearity operation, a normalization operation, a pooling operation, and/or the like.

In some implementations, the second hidden layer 524 includes a number of LSTM logic units 524a. In some implementations, the number of LSTM logic units 524a is the same as or similar to the number of LSTM logic units 520a in the input layer 520 or the number of LSTM logic units 522a in the first hidden layer 522. As illustrated in the example of FIG. 5, the second hidden layer 524 receives its inputs from the first hidden layer 522. Additionally and/or alternatively, in some implementations, the second hidden layer 524 receives its inputs from the input layer 520. For example, the second hidden layer 524 performs one or more of following: a convolutional operation, a nonlinearity operation, a normalization operation, a pooling operation, and/or the like.

In some implementations, the output layer 526 includes a number of LSTM logic units 526a. In some implementations, the number of LSTM logic units 526a is the same as or similar to the number of LSTM logic units 520a in the input layer 520, the number of LSTM logic units 522a in the first hidden layer 522, or the number of LSTM logic units 524a in the second hidden layer 524. In some implementations, the output layer 526 is a task-dependent layer that performs a computer vision related task such as feature extraction, object recognition, object detection, pose estimation, or the like. In some implementations, the output layer 526 includes an implementation of a multinomial logistic function (e.g., a soft-max function) that produces a number of outputs 530.

Neural networks, such as CNNs are often used to solve computer vision problems including feature extraction, object recognition, object detection, and pose estimation. A modern CNN is typically described as having an input layer, a number of hidden layers, and an output layer. In at least some scenarios, the input to the input layer of the CNN is an image frame while the output layer is a task-dependent layer. The hidden layers often include one of a plurality of operations such as convolutional, nonlinearity, normalization, and pooling operations. For example, a respective convolutional layer may include a set of filters whose weights are learned directly from data. Continuing with this example, the output of these filters are one or more feature maps that are obtained by applying filters to the input data of the convolutional layer.

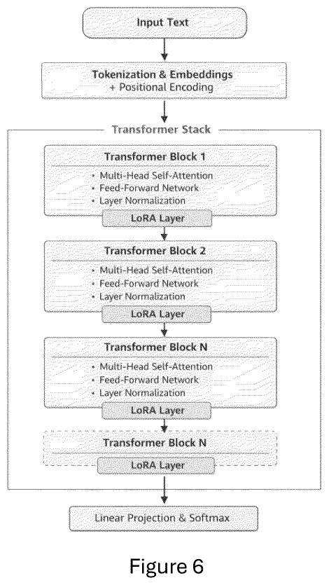

FIG. 6 illustrates an exemplary architecture of a large language model using a transformer-based neural network which may be implemented by embodiments of the present disclosure. While the example shown is based on a text input, it will be discussed herein and understood by those of ordinary skill that models may be configured and trained to receive inputs of various modalities, including but not limited to text, speech, audio, video, sensor data, or the like. In the depicted example, input data comprising natural language text, and optionally other data modalities, may be initially processed by a tokenization stage that converts the input into a sequence of tokens. The tokens may be mapped to corresponding embedding vectors, and positional encoding information may be combined with the embeddings to preserve the order of tokens within the sequence. The resulting token representations may be then provided as input to a transformer stack comprising a plurality of transformer blocks arranged in sequence.

Each transformer block within the stack may include one or more self-attention mechanisms configured to model contextual relationships among tokens across the input sequence, as well as one or more feed-forward neural network layers that apply non-linear transformations to the attention outputs.

Residual connections and normalization operations may be applied within each transformer block to stabilize training and facilitate information flow through the network. The outputs of successive transformer blocks may be iteratively refined as the representations propagate through the stack.

The output of the final transformer block may be provided to an output layer, which may include a linear projection and a softmax operation, to generate token-level probability distributions, predicted output tokens, or task-specific representations.

In some embodiments, additional components such as adapter layers, low-rank adaptation modules, or other parameter-efficient fine-tuning mechanisms may be incorporated within or between transformer blocks to enable task-or domain-specific adaptation without retraining the entire model.

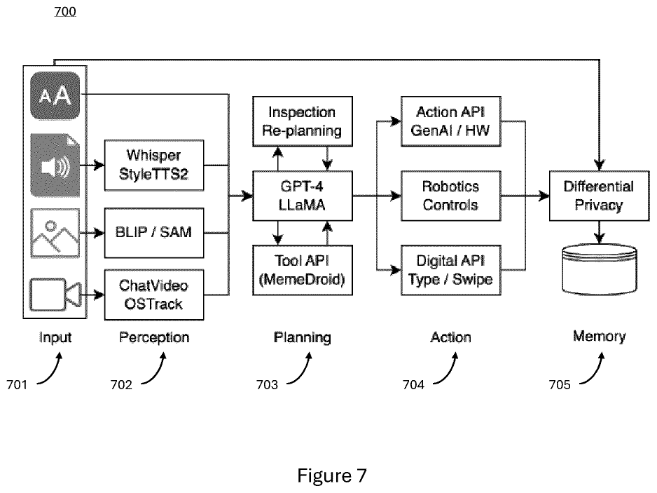

FIG. 7 depicts an example of a system 700 for providing a universal multi-modal AI home agent according to an embodiment of the present disclosure, wherein the system comprises four main components: a perception layer, a planning layer, an action layer, and a memory layer. The system 700 may be implemented at a server computer 120, 200, at a device 110, 300, 401, or be arranged across devices, including a server computer, and one or more devices. In some implementations, the system 700 may include multiple deployments at one or more devices within one environment, where the system includes a centralized computing device implementing one or more components of the system 700.

The system may receive an input 701 having diverse modalities, including but not limited to text, images, video, audio, sensor data, or the like. Based on the input, the perception layer 702 may extract relevant features from the diverse multimodal inputs. This may include image processing using vision processors and/or encoders, such as BLIP-2 and Grounding-DINO (for object recognition and fault detection), Segment Anything Model (SAM) (for precise part segmentation in appliances), Optical Character Recognition (OCR) tools (e.g., EasyOCR) for textual data extraction from images (e.g., error codes displayed on appliances)image processors and/or encoders such as Whisper (for speech-to-text conversion, enabling natural language troubleshooting queries), StyleTTS 2 (for text-to-speech synthesis to provide guidance or feedback in a human-like voice), video processors and/or encoders such as ChatVideo (for event detection and temporal reasoning in room surveillance or activity tracking) and Object-Specific Tracking (for object tracking for monitoring pets or moving elements in video feeds, configured to couple various modality inputs with a large language model.

In some embodiments, multimodal input fusion may be performed on embeddings by combined models like LLaVA-Interactive to process simultaneous inputs (e.g., a photo and a spoken query).

The planning layer 703 of the system 700 may be configured to dynamically create actionable plans by analyzing multimodal data and environmental context. In some embodiments, the planning layer 703 may include one or more trained machine learning models configured for reasoning and problem solving, comprising large language models, such as transformer-based models, e.g., GPT-4, GPT-5, LLaMA, that are fine-tuned using multimodal training datasets. The planning layer 703 may employ dynamic planning algorithms inspired by Chain-of-Thought (CoT) reasoning for breaking down an objective into a sequence of sub-tasks for step-by-step task decomposition. The resulting task plan may be represented as a structured sequence, graph, or hierarchy of executable actions.

In some embodiments, the planning layer 703 may be operatively integrated with APIs that enable interaction with external resources, databases, software libraries, or specialized functionality or tools. For example, the planning layer 703 may invoke image generation tools, appliance diagnostics, or the like. In some embodiments, the planning layer 701 may be implemented with self-instructive agents for learning task-specific tools dynamically, such as MemoDroid. Such agents may generate internal instructions or usage patterns for newly encountered tools, thereby enabling dynamic expansion of the system's functional capabilities without manual reconfiguration.

In some embodiments, the planning layer 703 includes tools for task inspection and adaptive re-planning. These mechanisms may include probabilistic evaluation techniques, such as Monte Carlo-based simulations, to assess alternative planning strategies and to refine existing strategies when initial plans fail, as well as self-check mechanisms to anticipate potential errors and adapt plans accordingly. Additionally, the planning layer 703 may include self-verification or self-checking processes configured to identify potential execution errors, inconsistencies, or failure conditions prior to or during task execution. Upon detection of such conditions, the system may automatically modify, regenerate, or reorder the planned actions to improve the likelihood of successful task completion.

The system 700 may further include an action execution layer 704 for executing planned actions generated by the planning layer 703 in physical and virtual environments. The action execution layer 704 may include a tool action module configured to interface with external application programming interfaces (APIs) and hardware protocols, wherein the APIs include visual generators, such as Stable Diffusion and DALLE-3, and the hardware control protocols include for example, Zigbee and Z-Wave for controlling smart appliances. The action execution layer 704 may also be configured to interface with robotics control libraries, including, but not limited to, ROS, for controlling physical robots.

The action execution layer 704 may further include an embodied actions module, or robotic controls module, for robotics control via deep reinforcement learning models for physical diagnostics, or otherwise interact with physical elements of an environment (e.g., opening appliance panels).

The action execution layer 704 may also include a virtual actions module for performing digital tasks such as providing alerts to users through mobile notifications or swiping/scrolling/typing in virtual interfaces, or outputting various outputs via components or devices in the environment.

Thus, the action execution layer 704 may output the executable action responsive to the input 701, which may include a query or action request. In some embodiments, the output of the action execution layer 704 may include a request for additional information or input, or may include a call to receive input of varying modality from alternate sources for additional processing by the perception and planning layers for generation of a final action to be executed.

Further, the system 700 may also include a memory layer 705 for storing and retrieving long-term knowledge for improved task adaptability and personalization. The memory layer 705 may provide personalization features, where user preferences, historical queries, and appliance-specific behaviors are stored for future use, and referenced by the perception, planning, or action layers.

The memory layer 705 may include privacy-centric memory storage models which use differential privacy for user preference storage to obscure sensitive user data, as well as supporting encryption for all memory interactions with compliance to local and any applicable regulations. The memory layer 705 may also include long-term memory module configured to manage data retention according to user-specified periods, with automatic deletion of expired data, and wherein sensitive data, including interaction logs, is stored on local devices whenever possible to minimize external exposure.

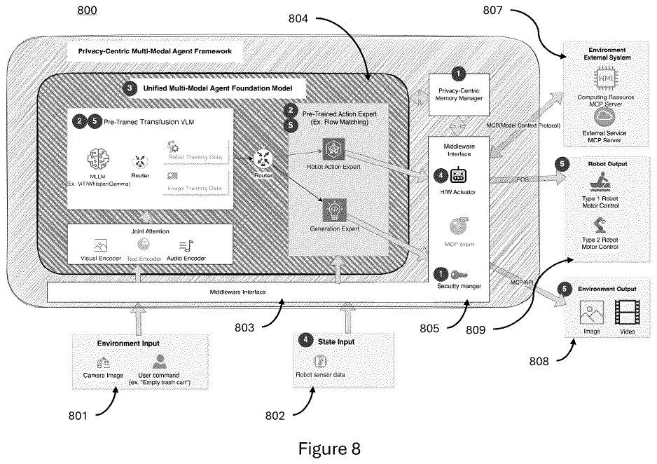

FIG. 8 is a diagram depicting a system 800 according to an embodiment of the present disclosure. As discussed with respect to FIG. 7, the system 800 may include a model that is fine-tuned with multi-modal datasets for reasoning and problem solving. In FIG. 8, the system includes a unified multi-modal agent foundation model 804 including a pre-trained transfusion vision-language model (VLM) using a unified transformer architecture rather than separate modules for modalities including vision and language. To provide tokenized input to the VLM, the system may include an input middleware interface 803 receiving input data from various environment input sources 801, 802, for example including cameras, sensors, microphones, user initiated input, speech, video, text, or the like. The input middleware interface may process the input data, performing tasks such as input validation and filtering, security authentication, context determination and labeling, input normalization and tokenization, generating embedded representations, or the like.

Once the input data is processed, the tokenized data may be provided to a joint attention module included in the multi-modal agent foundation model for generating contextualized shared tokens allowing for modality agnostic processing by the transformer. The one or more transformer layers of the attention module may be configured to compute attention scores for tokens based on various modality inputs, such that the tokens originating from different modalities may be associated with tokens of a different modality. Embodiments according to the disclosure improve computational efficiency, reduce system complexity, and enable the ability to apply pre-trained transfusion model processing using a multi-modal unified attention module.

The joint attention module may output the shared embeddings to the pretrained transfusion VLM (multimodal language model, MMLM) finetuned with multimodal datasets, such as robot training data, image training data, or the like, for dynamically creating actionable plans in response to the input by analyzing multimodal data and environmental context.

The foundation model may include a pre-trained action expert model trained to execute planned actions from the VLM in physical and virtual environments. The action expert model may be pre-trained on various APIs for output generation, including speech generation, image and video generation, as well as direct hardware control protocols such as Zigbee, Z-Wave for smart appliance operations. The action expert model may also output actions via control of robotic components such as a robotic arm, physical home appliance components, or may execute actions virtually, such as by providing or transmitting notifications or alerts.

Commands or executable actions from the action expert model may be output to an output middleware interface 805, which may include a hardware actuator for controlling physical environmental components, an MCP client for managing contextual information for action execution, and a security manager, configured to interface with the privacy-centric memory manager, for implementing differential privacy policy for data storage and retrieval. Based on processing by the output middleware interface, various action may be output to an environment external system 807 including a computing resource MCP server and an external service MCP server, to a robot 809 having various motor control components, or to an environment output 808 in the form of image, video, audio, or the like.

Further to the above, embodiments of the present disclosure may implement low-rank adaptation layers as a “Mixture-of-LoRa”, also referred to as “Mixture-of-Experts” (MoE) technique, to enable exponentially scalable multi-modal LLMs with context-aware fine-tuning and auto-regressive universal action experts, reducing data requirements for training through context-aware fine-tuning, and exponentially scaling universal skill sets through mixed-task training. Thus, models that are finetuned with multimodal datasets, such as robot training data, image training data, or the like, may be scaled easily to new data and tasks for dynamically creating actionable plans in response to new inputs or domains, and also dynamically add new action expert skill sets as the new inputs and domains are introduced.

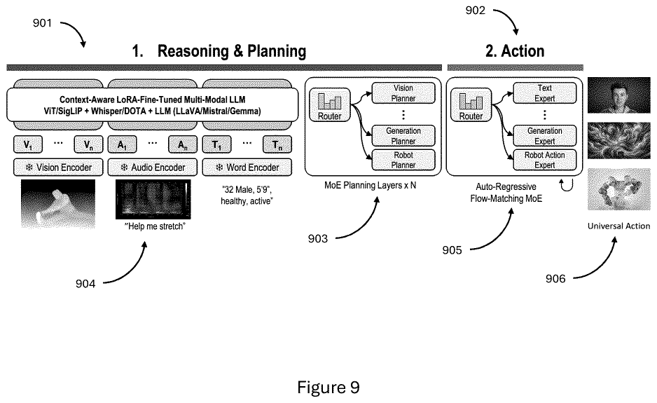

FIG. 9 is a diagram depicting an example of one architecture implementation of the unified multi-modal agent foundation model discussed in the above examples. The reasoning and planning 901 components of FIG. 9 may correspond to the perception and planning layers 702, 703 as discussed with respect to FIG. 7, or the joint attention and pre-trained transfusion VLM as discussed with respect to FIG. 8. The action 902 component of FIG. 9 may correspond to the action layer 704 of FIG. 7, or the pre-trained action expert module of FIG. 8. Thus, given particular multimodal inputs 904 (e.g., a camera captured image of a user stretching on the floor, a spoken audio input such as “Help me stretch”, and stored user associated data such as “32 Male, 5′9″, healthy, active”), various input encoders (e.g., VIT/SigLIP, Whisper/DOTA, or text encoders native to the LLM) which are fused together into the single multimodal LLM, are used to encode the input data including input normalization and tokenization and generating embedded representations.

As discussed, the embedded representations may be provided to a joint attention model to compute attention scores for tokens based on various modality inputs, such that the tokens originating from different modalities may be associated with tokens of a different modality.

The tokens from the attention model are then provided to the context-aware fine tuned multi-modal LLM for reasoning and planning processing. Included in some embodiments are MoE Planning Layers 903, which include several different planning layers implemented by low-rank adaptation (LoRa) layers inserted between transformer layers to provide various trained expertise for a particular input or domain, such as vision planner, image generation planner, robot planner, or the like. Each LoRa layer may also be trained on different API calls as well to access and retrieve data from external data sources or applications.

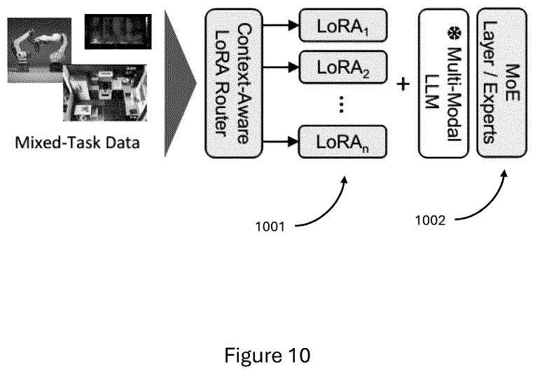

This is depicted in FIG. 10 which shows several LoRa layers 1001 configured to receive inputs having different weights from different layers. Each LoRa layer may introduce one or more additional parameter matrices having reduced dimensionality relative to the original weight matrix and be specially configured to enable to the model to handle different tasks or input domains, (e.g., vision processing, robot control processing, media generation processing, energy solutions, home monitoring, home appliances, etc.). Accordingly, when an input having a new domain is received, the model does not need to be entirely retrained to handle the input to generate an actionable plan, which would typically require a significant amount of data and computing time and resources.

Thus, implementation of specialized LoRa layers, each representing an “expert” knowledge base, task, or skill, in some cases implemented via trained APIs, may be incorporated into the LLM, allowing for lightweight scaling and specialty training of the LLM knowledge base while significantly reducing the number of trainable parameters required to adapt the model, thereby lowering computational cost, memory usage, and training time.

The model including the LoRa layers may be configured as an auto-regressive model in which an output using a specific expert LoRa layer may result in another specific expert LoRa layer handling a varying aspect of the input data along with LLM output context awareness to generate actionable plan output. In some embodiments, the model including one or more expert LoRa layers, may be a multi turn model and evaluate whether the available input data satisfies one or more task completion criteria. When the criteria are not satisfied, the model may generate an output indicating a request to the user for additional or necessary information which may be handled by one or more other LoRa layers of the model.

Similarly, the action layer 902 of the multi-modal agent foundation model may also implement the MoE in the form of LoRa layers 905 at the action execution layer. Similar to the reasoning and planning layer, the action execution layer may include a number of expert LoRa layers each representing an “expert” 1002 in executing actions corresponding to a particular knowledge base, task, or skill, in some cases implemented via trained APIs. The LoRa layers of the action execution layer may correspond one to one to the LoRa layers of the reasoning and planning layer, such that the actionable data generated by a particular expert LoRa layer of a particular knowledge base, task, or skill in the reasoning and planning layer may be routed to be handled by a corresponding expert LoRa layer for generating executable actions corresponding to the particular knowledge base, task, or skill.

In embodiment, the action layer 902 may be configured via the expert LoRa layers to output universal executable actions 906. These may include text/speech/digital human pose generation to output a response to a user via an interface, image or video generation, or robotic control. As discussed, the universal actions may also include specific regressive tool calling where the model requires additional input or data from other tools, APIs, or resources to be handled by different expert LoRa layers.

In some embodiments, additional expert LoRa layers may be added to an already trained and deployed multi-modal foundation model in the event of a completely new knowledge domain or category of skillset required to handle new inputs or new actions. Conversely, expert LoRa layers may be removed from an already trained and deployed multi-modal foundation model in the event that a knowledge base or skill set is rendered unnecessary or irrelevant.

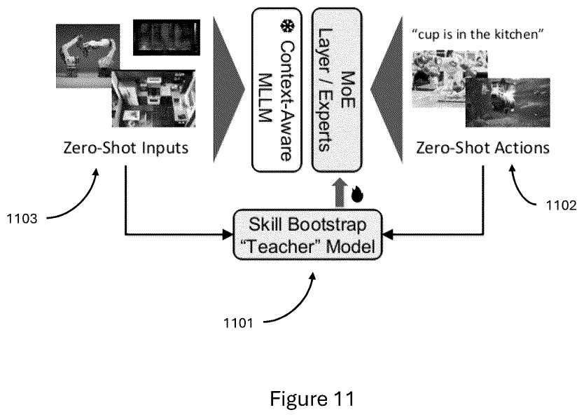

To address new required skillsets or actions without requiring the addition of retraining or adding new expert LoRa layers to the action layer, referring to FIG. 11, the system may also be configured to implement a MoE skill bootstrap model 1101 to allow for exponential scaling of model skill sets as new data, domains, and tasks are introduced.

The skill bootstrap teacher model 1101 may be implemented as a generalized AI agent or LLM which takes as input the executable action output 1102 by the action layer as well as the original input 1103 received from the user or environment. Particularly in cases involving zero shot inputs and outputs, i.e., an input and/or an output involving a knowledge base, domain, or task that the multi-modal agent has not been trained or fine-tuned to perform, the skill bootstrap teacher model may be trained to output a score indicating whether the zero shot action 1102 properly addressed the zero shot input 1103.

The output of the skill bootstrap teacher model 1101 may be used to train applicable expert LoRa layers of the action layer by reinforcement learning, to reinforce a correct action or train the LoRa to adapt a new skill or action based on an incorrectly generated action which was scored as not properly addressing the original input. The bootstrap skill teacher model may reside in the multi-modal foundation model and receive as input the output of the action execution layer as well as the original input to determine a score of how correct the executed action was.

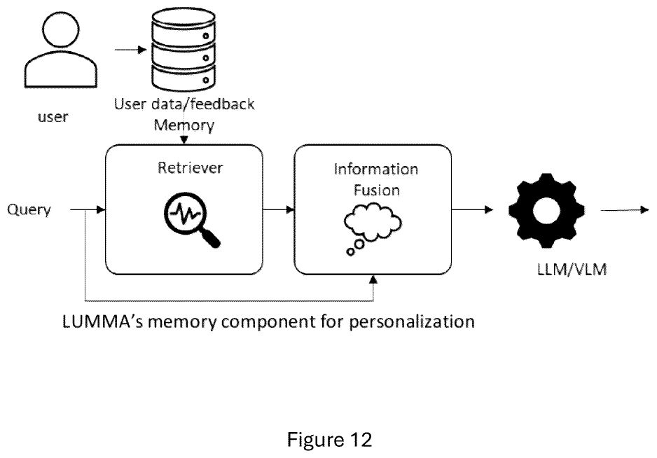

The system may also implement a persistent memory layer to support the multi-modal foundation layer, allowing for personalized interactions with the user while maintaining privacy. Referring to FIG. 12, the multi-modal agent framework may include a privacy-centric memory manager. User-related data may be collected, organized, and updated in the privacy-centric memory manager (see also FIG. 8) for efficient utilization in a Memory retrieval augmentation (memo-RAG) framework to provide personalized interactions with the user. Embodiments may utilize advanced solutions such as mem0 to provide dynamic memory interaction and provide session-spanning context awareness and controlled updates to the memory. Implementations of mem0 in the system utilize a hybrid database approach, combining vector, key-value, and graph databases to efficiently store and retrieve different types of information. Further improvements and interfacing with external knowledge through advanced techniques Astute RAG to overcome the conflict between memory, RAG and parametric knowledge are considered in this disclosure.

Regarding the memory manager, the system may implement differential privacy preserving techniques including anonymizing data processing, end-to-end encryption for multimodal data transmission, real-time anomaly detection to identify potential data breaches or unauthorized access, privacy configuration options for users to control data collection and sharing enabling agility in choices of privacy-preserving methods to comply with user preferences, types of data or specific use-cases, and federated learning for local model training to minimize raw data transfer, which may also be combined with fully homomorphic encryption to protect raw data.

Embodiments of the present disclosure may benefit from enhanced reasoning through automatic prompt optimization, intrinsic self-refinement and structural utilization without the need to scale up the model and improved planning through tree, efficient search and dynamic world model. The embodiments may provide improved reasoning through automatic prompt optimization and intrinsic self-refinement, including: Automatic Prompt Engineering (APE) and optimization(APO) strategies, text-based gradients (TextGrad), Gradients over reasoning such as Greater, Non-parametric approaches such as Recursive Criticism and improvement, Self Refine and Reflexion, and Parametric approaches such as ReGenesis (Self-synthesize reasoning path) & ScoRe (a multiturn online RL).

The embodiments may provide Improved Reasoning Through Incorporating Structures in LLMs/VLMs, including: Symbolic constraints such as injecting human constraints, mathematical and programming constraints, Task decomposition such as rule based alignment, guided visual search, sketching as a Visual Chain of Thought, Cognitive procedures such as analogical reasoning, implicit reasoning such as Quiet-Star, and Early fusion at training time can bake in additional structures into the generation process.

Embodiments of the present disclosure may also provide improvements in Planning Through Tree and Efficient Search, including: Tree search to enable the exploration of multiple paths to find potentially optimal ones, Improvements in searching and pruning to limit exploration overhead, integrate look-ahead planning, and utilizing historical learning for proactive and preemptive pruning.

Further, embodiments may also include improvements in Planning Through Dynamic World Model, including: defining world models as candidate pools of actions and states, and predicting states conditioned on actions, approximation for the current environment, and multi-view encoding of visual environments.

Embodiments of the present disclosure also present distinct improvements over systems of the existing art, including improvements in: perception: multimodal input support (text, audio, video, images), ability to analyze environmental data in real-time; planning & reasoning: chain-of-thought reasoning to dynamically plan responses, integration with memory for personalized user experience; scalable expert layers using MoE; action execution: support for virtual actions (e.g., generating visuals, suggesting solutions), physical action triggers for robotics (e.g., alerts, navigation), scalable action layers using MoE, reinforcement learning of MoE via skill bootstrap teacher model; and memory: storing previous interactions and successful resolutions, and long-term memory for recognizing recurring events or issues.

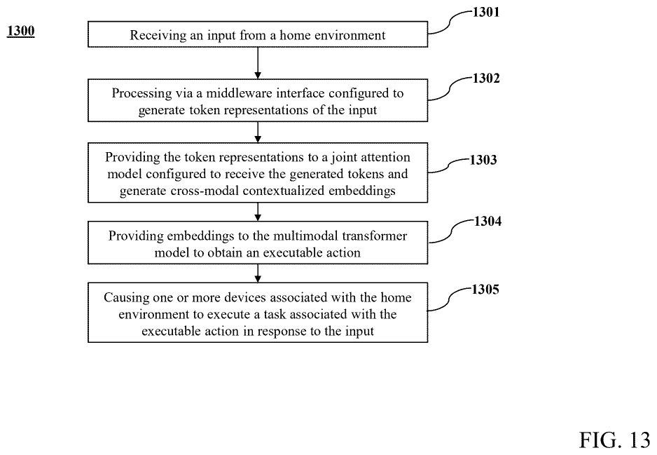

Referring to FIG. 13, an example of a method for providing a multimodal AI home agent is provided. According to an embodiment, the method may include: receiving an input from a home environment (1301), processing the input via a middleware interface associated with a multimodal transformer model configured to process input data having at least two modalities, wherein the middleware interface is configured to generate token representations of the input (1302), providing the token representations to a joint attention model configured to receive the generated tokens and generate cross-modal contextualized embeddings (1303), providing the embeddings to the multimodal transformer model to obtain an output representing an executable action in response to the input (1304), and causing one or more devices associated with the home environment to execute a task associated with the executable action in response to the input. It will be understood by those of ordinary skill that the various configurations of embodiments discussed above are considered separately, or in combination, as being applicable to the example of the method of FIG. 13, and well as other non-limiting examples.

The following are non-limiting examples of scenarios in which embodiments of the present disclosure may be applied to provide a multi-modal unified foundation agent, as discussed herein. Those of ordinary skill will appreciate the depth and scope of the disclosure discussed above, and recognize that the present disclosure shall not be limited to following, which are provided only by way of example.

### Appliance Error Detection & Repair Guidance

Scenario: A user notices an issue with their washing machine. They take a photo of the malfunctioning area and ask, “What's wrong with my washer?” The agent analyzes the image, identifies the problem as a clogged drain, and displays step-by-step guidance on the TV while narrating the instructions.
Multimodality: Image recognition (photo of the appliance), visual and voice-guided instructions, and text summaries for reference.

### Knob and Feature Identification

Scenario: A user takes a picture of a knob on their oven and asks, “What does this do?” The assistant identifies the control as the convection bake setting and explains its function through a short video tutorial on their phone.
Multimodality: Image recognition for identifying the knob, text explanation, and video demonstration.

### Proactive Issue Monitoring

Scenario: The agent detects a performance drop in the dishwasher and sends a notification: “Your dishwasher's water pressure is low. Would you like me to guide you through cleaning the filter?” If the user agrees, the agent provides a video tutorial and checks the status after the cleaning is complete.
Multimodality: Sensor data monitoring, text notifications, and video-based troubleshooting.

### Service Booking Integration

Scenario: After attempting to fix the refrigerator's cooling issue, the user asks, “Can I book a technician?” The agent schedules a service appointment, sharing the error code and photos with the technician for faster resolution.
Multimodality: Voice request, photo analysis, and integration with booking systems.

### Real-Time Troubleshooting

Scenario: A user encounters a strange noise from the dryer. They record a short video of the appliance running and upload it to the agent. The assistant analyzes the sound and video, identifies a loose belt, and suggests tightening it, with a link to a compatible toolkit if needed.
Multimodality: Video and audio analysis, voice guidance for repairs, and text-based product recommendations.

### Proactive Home Fitness Companion

Scenario: The agent detects the user laying out a yoga mat and starting stretches. It activates “Yoga Mode” by: Displaying serene water visuals on the TV; Syncing a calming yoga playlist with connected speakers; Dimming the room lights and setting the thermostat to a comfortable 72° F.; Disabling kitchen appliances like the oven or dishwasher to ensure a quiet, distraction-free session.
Multimodality: Activity detection, visual generation (TV), audio syncing, and smart device controls (lights, thermostat, appliances).

### Proactive Family Gathering Mode

Scenario: The agent detects multiple people in the dining area and the sound of clinking dishes. It activates “Family Gathering Mode” by: Displaying a warm, candlelight-like animation on the TV; Syncing a jazz playlist on the speakers; Adjusting the lights to a soft, warm glow; Lowering the thermostat by a few degrees to counteract the heat generated by cooking or multiple people in the room; Suggesting a notification to the fridge to auto-chill beverages.
Multimodality: Audio and motion detection, visual and audio syncing, and environmental adjustments (lights, thermostat, and fridge controls).

### Proactive Personal Relaxation

Scenario: The agent notices the user closing their work laptop and reclining on the couch. It activates “Relaxation Mode” by: Displaying calming ocean wave visuals on the TV; Playing a relaxation playlist on the speakers; Dimming the lights gradually and setting them to a cooler color tone; Adjusting the thermostat to a cozy 74° F.; Suggesting to preheat the oven for dinner or make a cup of tea by activating the connected kettle.
Multimodality: Behavioral recognition, visual and audio syncing, lighting control, and appliance integration.

### Proactive Dynamic Atmosphere Adjustment

Scenario: The agent detects increased noise levels and fast movements in the living room, indicating a game night. It activates “Game Night Mode” by: Displaying dynamic, colorful visuals on the TV that match the energy of the gathering; Playing an energetic playlist on the speakers; Setting the lights to pulse with the music and adding color effects; Adjusting the thermostat to a cooler setting to counteract body heat from the activity; Suggesting turning off the washing machine or dishwasher to minimize background noise.
Multimodality: Environmental detection (noise/motion), visual/audio syncing, lighting effects, thermostat control, and appliance management.

### Pet Health and Behavior Insights

Scenario: A user asks, “How is my dog doing today?” The AI reviews video footage, detects reduced activity levels, and analyzes audio for unusual vocalizations like excessive barking. It responds, “Your dog has been less active today compared to the usual. No unusual sounds detected. Should I suggest a vet appointment if this persists?”
Multimodality: Video monitoring (activity tracking), audio analysis (vocalizations), and text/voice summaries.

### Object Tracking and Alerts

Scenario: The user says, “Where is the TV remote?” The AI scans the home using the robot's camera, locates the TV remote under the couch, and shares a picture on the user's phone with a voice response: “Your TV remote is under the living room couch.”
Multimodality: Object recognition (locating the TV remote), video capture (photo of location), and voice/text notifications.

### Dynamic Pet Interaction

Scenario: A user, while at work, sends a command: “Show me how my cat is doing.” The AI activates the robot to locate the cat, analyzes video for activity (e.g., playing with a toy), and sends a live video feed. If the cat hasn't eaten, it reminds the user: “Your cat hasn't accessed its food bowl since this morning. Should I activate the feeder?”
Multimodality: Video monitoring (locating the pet), live video feed (real-time updates), and integration with smart devices (feeder activation).

### Environmental Hazard Detection and Action

Scenario: The AI detects water pooling in the laundry room via its camera. It notifies the user with a video clip and says, “Water detected near the washing machine. Should I shut off the water supply?” The user can respond with a voice command to take immediate action.
Multimodality: Video analysis (water detection), voice commands (user response), and actionable device control (shutting off water).

### Unusual Object Detection

Scenario: The AI robot notices an unidentified object (e.g., a delivery box) left near the back door. It takes a photo, shares it with the user, and says, “A new object was detected near the back door. Would you like me to monitor this area for additional activity?”
Multimodality: Object detection (new item identification), photo capture (evidence), and voice/text alerts for user decision-making.

Implementations according to the present disclosure described above may be implemented in the form of computer programs that may be executed through various components on a computer, and such computer programs may be recorded in a computer-readable medium. Examples of the computer-readable media include, but are not limited to: magnetic media such as hard disks, floppy disks, and magnetic tape; optical media such as CD-ROM disks and DVD-ROM disks; magneto-optical media such as floptical disks; and hardware devices that are specially configured to store and execute program codes, such as ROM, RAM, and flash memory devices.

Meanwhile, the computer programs may be those specially designed and constructed for the purposes of the present disclosure or they may be of the kind well known and available to those skilled in the computer software arts. Examples of program code include both machine codes, such as produced by a compiler, and higher level code that may be executed by the computer using an interpreter.

As used in the present disclosure (especially in the appended claims), the singular forms “a,” “an,” and “the” include both singular and plural references, unless the context clearly states otherwise. Also, it should be understood that any numerical range recited herein is intended to include all sub-ranges subsumed therein (unless expressly indicated otherwise) and accordingly, the disclosed numeral ranges include every individual value between the minimum and maximum values of the numeral ranges.

Operations constituting the method of the present disclosure may be performed in appropriate order unless explicitly described in terms of order or described to the contrary. The present disclosure is not necessarily limited to the order of operations given in the description. All examples described herein or the terms indicative thereof (“for example,” etc.) used herein are merely to describe the present disclosure in greater detail. Therefore, it should be understood that the scope of the present disclosure is not limited to the example implementations described above or by the use of such terms unless limited by the appended claims. Therefore, it should be understood that the scope of the present disclosure is not limited to the example implementations described above or by the use of such terms unless limited by the appended claims. Also, it should be apparent to those skilled in the art that various alterations, substitutions, and modifications may be made within the scope of the appended claims or equivalents thereof.

Therefore, technical ideas of the present disclosure are not limited to the above-mentioned implementations, and various alterations, substitutions, and modifications thereof will be considered to fall within the scope of the present disclosure.

What is claimed is:

1. A computer-implemented device for providing a multimodal artificial intelligence (AI) home agent, the device comprising:
one or more processors; and
a memory configured to store instructions thereon, which when executed by the one or more processors, causes the device to operate a multimodal transformer model configured to process input data having at least two modalities and perform operations including:
receiving an input from a home environment;
processing the input via a middleware interface configured to generate token representations of the input;
providing the token representations to a joint attention model configured to receive the generated tokens and generate cross-modal contextualized embeddings,
providing the embeddings to the multimodal transformer model to obtain an output representing an executable action in response to the input; and
causing one or more devices associated with the home environment to execute a task associated with the executable action in response to the input.

2. The device of claim 1, wherein the joint attention model is included in a perception layer of the multimodal transformer model that is configured to extract relevant features from input data having the at least two modalities including at least text data, image data, video data, or audio data.

3. The device of claim 2, wherein the multimodal transformer model further includes a planning layer configured to generate an actionable plan responsive to the input based on the provided embeddings, and
wherein the planning layer is trained using a plurality of input low-rank adaptation (LoRa) layers each dedicated to training parameters of the model for generating the actionable plan on a distinct expert knowledge base.

4. The device of claim 3, wherein the multimodal transformer model further includes an action layer configured to generate the executable action based on the actionable plan, and
wherein the action layer is trained using a plurality of output low-rank adaptation (LoRa) layers each dedicated to training parameters of the model for generating the executable action on a distinct expert skillset base.

5. The device of claim 4, wherein the expert knowledge bases of the plurality of input LoRa layers respectively correspond to the expert skillset bases of the plurality of output LoRa layers.

6. The device of claim 4, wherein one or more of the plurality of output LoRa layers are configured to be further trained to adapt a new expert skillset base by a skill bootstrap teacher model,
wherein the skill bootstrap teacher model is configured to receive as input the input received from the home environment and the executed task associated with the executable action and generate a score for the executed task, and
wherein the score is used to train the one or more of the plurality of output LoRa layers to improve the executed task by reinforcement learning.

7. The device of claim 4, wherein the output from the multimodal transformer model includes a request to a user of the home environment for additional data or information related to the received input.

8. The device of claim 4, wherein the output from the multimodal transformer model generated using one input LoRa layer and one output LoRa layer is utilized in a subsequent processing by the multimodal transformer model which invokes processing by another input LoRa layer and another output LoRa layer.

9. The device of claim 4, wherein the memory is further configured to store user-related data for utilization in a memory retrieval augmentation framework and the operations further comprise providing a memory manager for providing the multimodal transformer model with personalized data to be considered in executing the task in response to the input.

10. The device of claim 4, wherein the distinct expert skillset bases of the plurality of output LoRa layers comprise skillsets for speech generation, image generation, and robotic component controls.

11. A computer-implemented method for providing a multimodal artificial intelligence (AI) home agent, the method comprising:
receiving an input from a home environment;
processing the input via a middleware interface associated with a multimodal transformer model configured to process input data having at least two modalities, wherein the middleware interface is configured to generate token representations of the input;
providing the token representations to a joint attention model configured to receive the generated tokens and generate cross-modal contextualized embeddings;
providing the embeddings to the multimodal transformer model to obtain an output representing an executable action in response to the input; and
causing one or more devices associated with the home environment to execute a task associated with the executable action in response to the input.

12. The method of claim 11, wherein the joint attention model is included in a perception layer of the multimodal transformer model that is configured to extract relevant features from input data having the at least two modalities including at least text data, image data, video data, or audio data.

13. The method of claim 12, wherein the multimodal transformer model further includes a planning layer configured to generate an actionable plan responsive to the input based on the provided embeddings, and
wherein the planning layer is trained using a plurality of input low-rank adaptation (LoRa) layers each dedicated to training parameters of the model for generating the actionable plan on a distinct expert knowledge base.

14. The method of claim 13, wherein the multimodal transformer model further includes an action layer configured to generate the executable action based on the actionable plan, and
wherein the action layer is trained using a plurality of output low-rank adaptation (LoRa) layers each dedicated to training parameters of the model for generating the executable action on a distinct expert skillset base.

15. The method of claim 14, wherein the expert knowledge bases of the plurality of input LoRa layers respectively correspond to the expert skillset bases of the plurality of output LoRa layers.

16. The method of claim 14, wherein one or more of the plurality of output LoRa layers are configured to be further trained to adapt a new expert skillset base by a skill bootstrap teacher model,
wherein the skill bootstrap teacher model is configured to receive as input the input received from the home environment and the executed task associated with the executable action and generate a score for the executed task, and
wherein the score is used to train the one or more of the plurality of output LoRa layers to improve the executed task by reinforcement learning.

17. The method of claim 14 wherein the output from the multimodal transformer model includes a request to a user of the home environment for additional data or information related to the received input.

18. The method of claim 14, wherein the output from the multimodal transformer model generated using one input LoRa layer and one output LoRa layer is utilized in a subsequent processing by the multimodal transformer model which invokes processing by another input LoRa layer and another output LoRa layer.

19. The method of claim 14, further comprising storing user-related data for utilization in a memory retrieval augmentation framework and providing the multimodal transformer model with personalized data based on the user-related data to be considered in executing the task in response to the input.

20. The method of claim 14, wherein the distinct expert skillset bases of the plurality of output LoRa layers comprise skillsets for speech generation, image generation, and robotic component controls.
